(19) United States
(12) Patent Application Publication
(10) Pub. No.: US 2025/0330974 A1
(43) Pub. Date: Oct. 23, 2025

(54) SINGLE DOWNLINK CONTROL INFORMATION (DCI) MESSAGE SCHEDULING MULTIPLE TRANSPORT BLOCKS OVER MULTIPLE TIME SLOTS WITH PARTIAL DEMODULATION REFERENCE SIGNALS (DMRS)

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/640,877

(22) Filed: Apr. 19, 2024

(51) Int. Cl. H04W 72/1268; H04L 5/00; H04W 72/21; H04W 72/232

(52) U.S. Cl. CPC H04W 72/1268; H04L 5/0051; H04W 72/21; H04W 72/232

(57) ABSTRACT

A method for wireless communication by a user equipment (UE) includes receiving a single downlink control information (DCI) message scheduling a number of uplink transport blocks across multiple time slots. The method further includes processing the single DCI message to configure partial demodulation reference signal (DMRS) symbols across the time slots such that at least one of the time slots contains less than a quantity of previously configured DMRS symbols.

### FIELD OF THE DISCLOSURE

The present disclosure relates generally to wireless communications, and more specifically to a single downlink control information (DCI) message scheduling multiple transport blocks (TBs) over multiple time slots with partial demodulation reference signals (DMRS).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication by a user equipment (UE) includes receiving a single downlink control information (DCI) message scheduling a number of uplink transport blocks across multiple time slots. The method still further includes processing the single DCI message to configure partial demodulation reference signal (DMRS) symbols across the time slots such that at least one of the time slots contains less than a quantity of previously configured DMRS symbols.

In other aspects of the present disclosure, a method of wireless communication by a network device includes transmitting a single downlink control information (DCI) message scheduling a number of uplink transport blocks across a number of time slots, the single DCI message configuring partial demodulation reference signal (DMRS) symbols across the time slots such that at least one of the time slots contains less than a quantity of previously configured DMRS symbols.

Other aspects of the present disclosure are directed to an apparatus. The apparatus has one or more memories and one or more processors coupled to the one or more memories. The processor(s) is configured to receive a single downlink control information (DCI) message scheduling a number of uplink transport blocks across multiple time slots. The processor(s) is still further configured to process the single DCI message to configure partial demodulation reference signal (DMRS) symbols across the time slots such that at least one of the time slots contains less than a quantity of previously configured DMRS symbols.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4A and 4B are block diagrams illustrating two types of placement for demodulation reference signals (DMRS).

FIG. 5 is a timeline illustrating physical uplink shared channel (PUSCH) repetition type A.

FIG. 6 is a timeline illustrating transport block (TB) processing over multiple slots (TBOMS).

FIG. 7 is a block diagram illustrating joint channel estimation.

FIG. 8 is a block diagram illustrating unused transmission occasion-uplink control information (UTO-UCI) carried on a physical uplink shared channel (PUSCH).

FIG. 9 is a call flow diagram illustrating single DCI scheduling of multiple transport blocks over multiple slots with partial DMRS, in accordance with various aspects of the present disclosure.

FIG. 10 is a flow diagram illustrating an example process performed, for example, by a user equipment (UE), in accordance with various aspects of the present disclosure.

FIG. 11 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

User equipment (UEs) receive physical downlink control channels (PDCCHs) from base stations carrying uplink and downlink grants. Some PDCCHs may be prevented from transmitting, however, due to a lack of available control channel elements (CCEs) for carrying the PDCCH. For example, approximately thirty percent of physical resource block (PRB) usage may be allocated for physical downlink shared channel (PDSCH) transmission. Consequently, some UEs may not be scheduled due to the large number of DCI messages needed for scheduling. If a UE is close to a base station, only a single CCE may be needed to carry the PDCCH for uplink and downlink grants. If the UE is far from the base station, more CCEs may be needed, for example, twelve CCEs.

Another issue with current protocols is that throughput may be impacted by the high overhead associated with demodulation reference signals (DMRS). DMRS may be specified for both PDSCH and physical uplink shared channel (PUSCH) transmissions. High overhead results in low spectrum efficiency.

According to aspects of the present disclosure, PDCCH blocking is addressed by allowing a single DCI message to schedule multiple TBs over multiple time slots to reduce CCE consumption. The UE may skip remaining uplink (UL) slots if there is no more data in the UE buffer.

Aspects of the present disclosure address DMRS overhead by allowing dynamic or adaptive partial or no DMRS transmissions in the time domain based on channel conditions, application traffic burst specifications, application quality of service (QoS) latency specifications, and/or UE mobility. A bit map may indicate which slots carry DMRS and which slots do not carry DMRS. Data may be carried in the symbols that do not carry DMRS, thereby reducing overhead.

Particular aspects of the subject matter described in this disclosure can be implemented to realize one or more of the following potential advantages. In some examples, the described techniques, such as receiving a single DCI message for scheduling multiple transport blocks over multiple time slots with partial DMRS, may increase throughput and spectrum utilization.

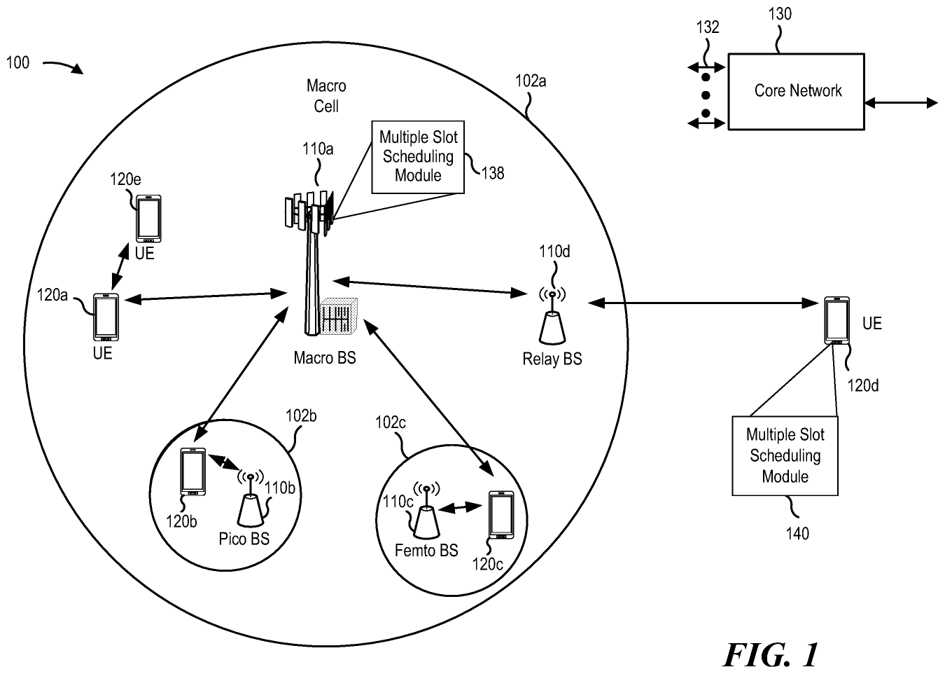

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a multiple slot scheduling module 140. For brevity, only one UE 120d is shown as including the multiple slot scheduling module 140. The multiple slot scheduling module 140 may receive a single downlink control information (DCI) message scheduling a number of uplink transport blocks across a number of time slots. The multiple slot scheduling module 140 may process the single DCI message to configure partial demodulation reference signal (DMRS) symbols across the time slots such that at least one of the time slots contains less than a quantity of previously configured DMRS symbols.

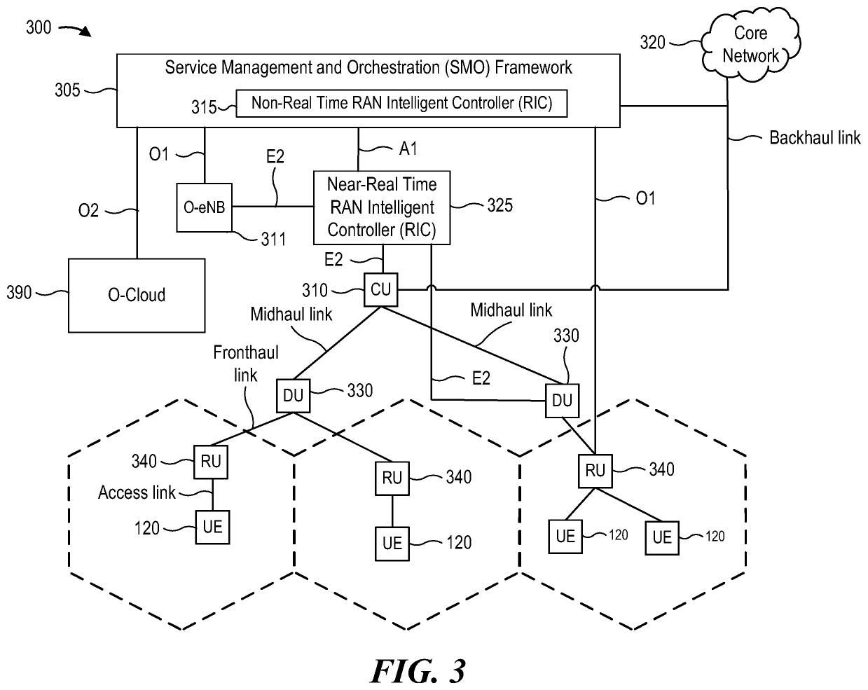

The core network 130 or the base stations 110 or any other network device (e.g., as seen in FIG. 3) may include a multiple slot scheduling module 138. For brevity, only one base station 110 is shown as including the multiple slot scheduling module 138. The multiple slot scheduling module 138 may transmit a single downlink control information (DCI) message scheduling a number of uplink transport blocks across a number of time slots, the single DCI message configuring partial demodulation reference signal (DMRS) symbols across the time slots such that at least one of the time slots contains less than a quantity of previously configured DMRS symbols.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

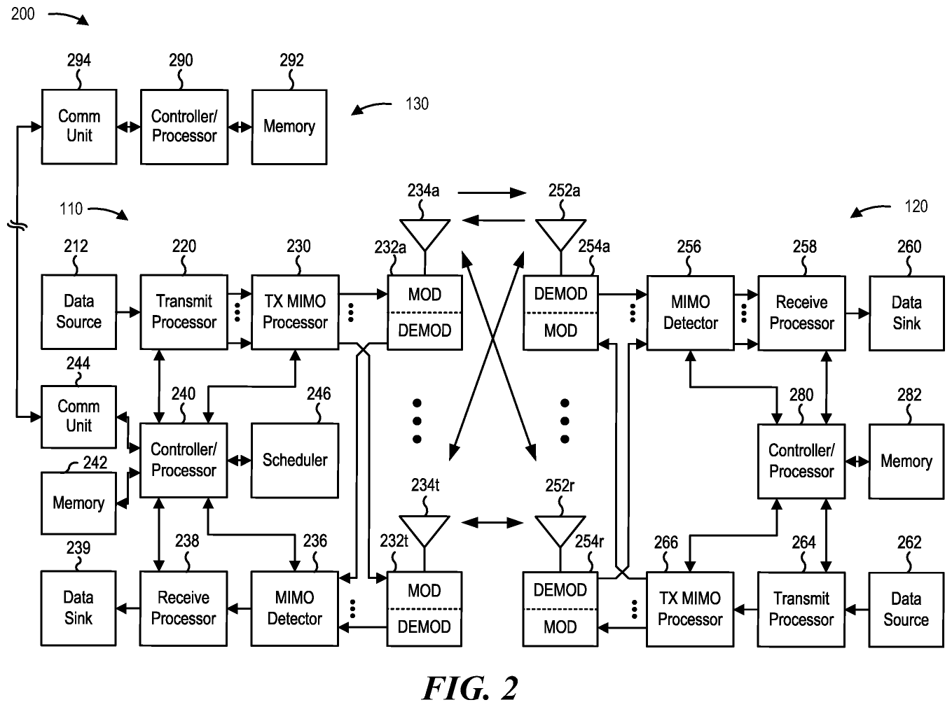

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

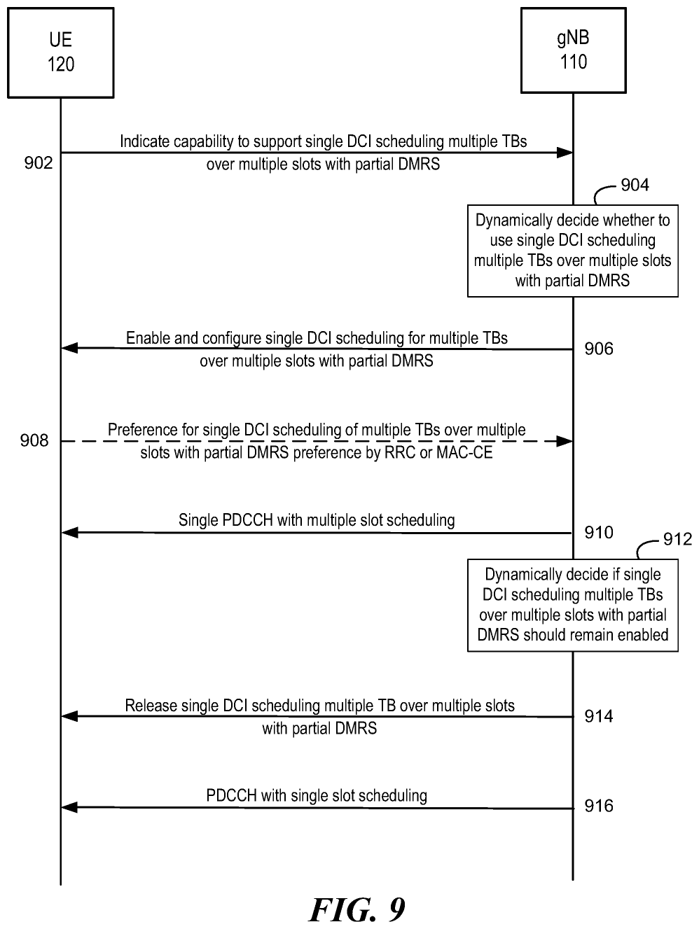

The controller/processor 240 of the base station 110, the controller/processor 280 of the UE 120, and/or any other component(s) of FIG. 2 may perform one or more techniques associated with multiple slot scheduling as described in more detail elsewhere. For example, the controller/processor 240 of the base station 110, the controller/processor 280 of the UE 120, and/or any other component(s) of FIG. 2 may perform or direct operations of, for example, the processes of FIGS. 9-11 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for processing, means for transmitting, means for performing, and means for requesting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (CNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an Al interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

UEs receive physical downlink control channels (PDCCHs) from base stations carrying uplink and downlink grants. Some PDCCHs may be prevented from transmitting, however, due to a lack of available control channel elements (CCEs) for carrying the PDCCH. For example, approximately thirty percent of physical resource block (PRB) usage may be allocated for physical downlink shared channel (PDSCH) transmission. Consequently, some UEs may not be scheduled. If a UE is close to a base station, only a single CCE may be needed to carry the PDCCH for uplink and downlink grants. If the UE is far from the base station, more CCEs may be needed, for example, twelve CCEs.

Another issue with current protocols is that throughput may be impacted by the high overhead associated with demodulation reference signals (DMRS). DMRS may be specified for both PDSCH and physical uplink shared channel (PUSCH) transmissions. High overhead results in low spectrum efficiency.

The DMRS carries a precoding matrix indicator (PMI) for non-code book based multiple-input, multiple-output (MIMO) transmissions in new radio (NR) communications. The same precoding may be applied for two, four, or all physical resource blocks (PRBs) allocated to a user equipment (UE) with PRB bundling.

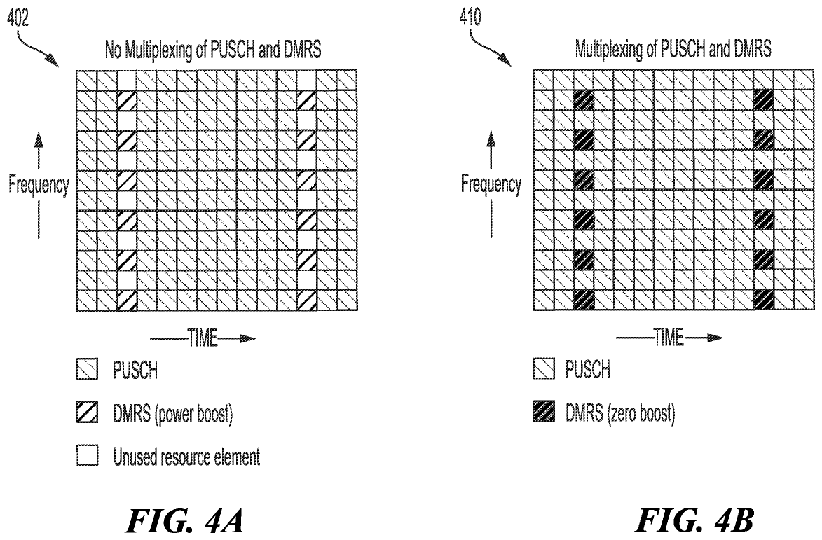

FIGS. 4A and 4B are block diagrams illustrating two types of placement for demodulation reference signals (DMRS). In FIGS. 4A and 4B, each slot 402, 410 includes 14 symbols (each symbol represented as a column in the time domain), where one physical resource block (PRB) includes 12 resource elements (each resource element represented as a block). In the examples of FIGS. 4A and 4B, each symbol corresponds to a physical resource block. The first, second, fourth, fifth, sixth, seventh, eighth, ninth, tenth, eleventh, thirteenth, and fourteenth symbols carry the physical uplink shared channel (PUSCH). In FIG. 4A, the third and twelfth symbols carry boosted DMRS multiplexed with unused resource elements. In FIG. 4B, the third and twelfth symbols carry a zero boost DMRS multiplexed with PUSCH.

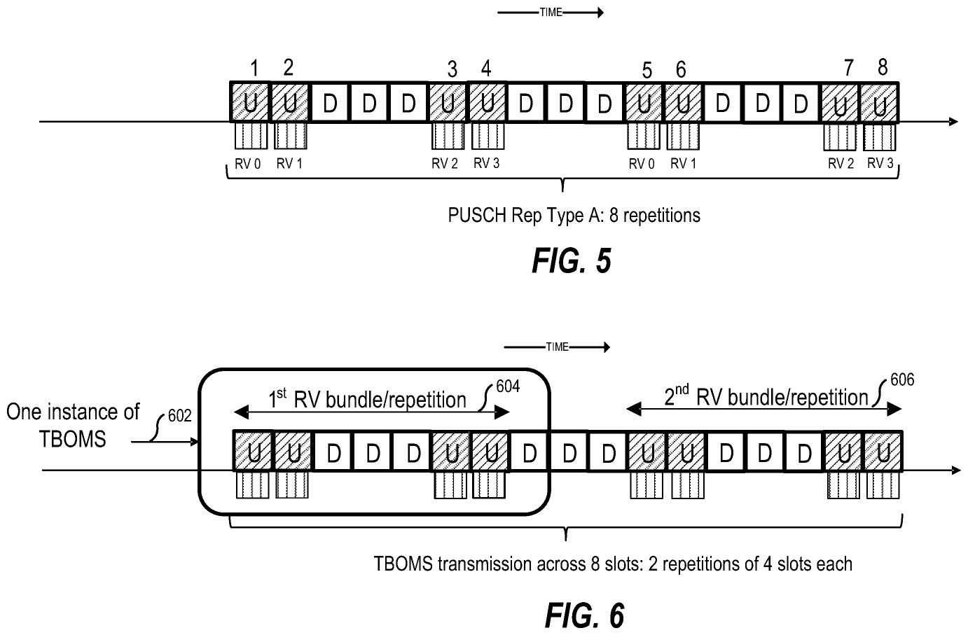

Transport block (TB) processing over multiple slots (TBOMS) has been introduced in which a PUSCH repetition type A framework is reused. FIG. 5 is a timeline illustrating PUSCH repetition type A. In PUSCH repetition type A, a TB size is based on a configured time domain resource allocation (TDRA), frequency domain resource allocation (FDRA), and modulation and coding scheme (MCS). The TB size is independent of a number of repetitions. In the example of FIG. 5, eight repetitions (e.g., 1, 2, 3, 4, 5, 6, 7, 8) of a single PUSCH are shown. The ‘U’ time slots correspond to uplink time slots and the ‘D’ timeslots correspond to downlink time slots. Repetitions 1 and 5 correspond with redundancy version (RV) 0, repetitions 2 and 6 correspond with redundancy version 1, repetitions 3 and 7 correspond with redundancy version 2, and repetitions 4 and 8 correspond with redundancy version 3.

FIG. 6 is a timeline illustrating transport block processing over multiple slots (TBOMS). For TBOMS, two changes are introduced relative to PUSCH repetition type A. First, a collection of N slots is viewed as a single transmission and the TB size is scaled by a factor of N. Second, the redundancy version (RV) refreshes once every N slots, and coded bits are mapped from the circular buffer continuously across the N slots. In the example of FIG. 6, an instance of TBOMS 602 includes a first RV bundle/repetition 604 and a second RV bundle/repetition 606. The TBOMS transmission in the example of FIG. 6 is across eight slots, with two repetitions of four slots each. That is, a single transport block is transmitted across multiple slots (eight slots in this example).

Channel estimation was previously constrained to be within a single slot. No coherence was required across slots. For cell edge UEs, improving channel estimation may help increase throughput. DMRS bundling has been introduced to enable joint processing of DMRS symbols across multiple slots. Joint channel estimation is permitted if the transmitter is able to maintain phase coherence across slots.

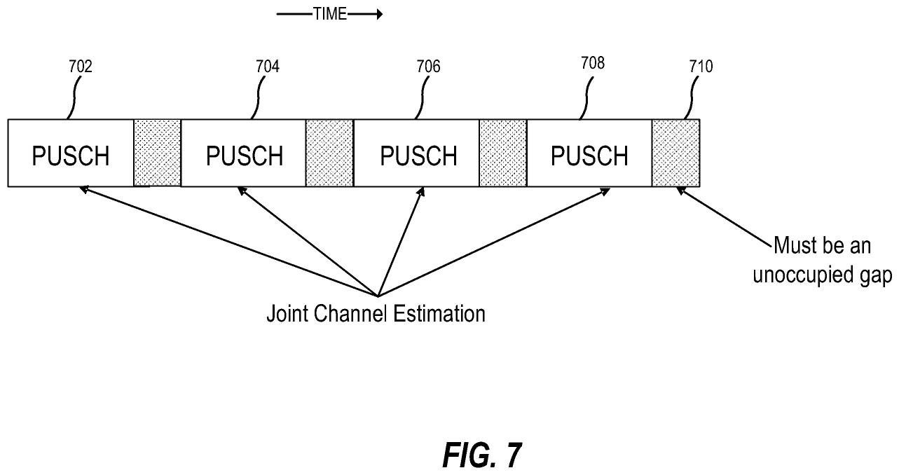

FIG. 7 is a block diagram illustrating joint channel estimation. In the example of FIG. 7, a UE transmits PUSCH in four slots 702, 704, 706, 708. Each PUSCH has two symbols of DMRS, for example, as shown in FIGS. 4A and 4B. Based on the DMRS in the four slots 702, 704, 706, 708, joint channel estimation may occur, as long as phase coherence is maintained across the slots 702, 704, 706, 708.

DMRS bundling is supported only across PUSCH or physical uplink control channel (PUCCH) repetitions. For example, type A repetitions, type B repetitions (single layer only), and TBOMS are supported. DMRS bundling only applies to long format PUCCH (e.g., PUCCH format 0 and 2 are precluded). Moreover, no bundling is permitted across different TBs. Bundling only occurs across consecutive slots. Bundling across non-back-to-back PUSCH repetitions is allowed (e.g., gaps less than 14 symbols can occur).

If an intervening uplink transmission occurs between two repetitions, or downlink monitoring or downlink reception is required, then phase continuity is assumed to be broken. DMRS bundling is not possible when phase continuity is broken. Referring back to FIG. 7, a gap 710 between slots should be an unoccupied gap, if bundling is permitted. DMRS bundling is applicable to all modulation orders.

Configured grant (CG)-based PUSCH is now discussed. Unused transmission occasion-uplink control information (UTO-UCI) allows a UE to indicate used and unused PUSCH transmission occasions. A bitmap is used in the UTO-UCI to indicate whether a preconfigured transmission occasion will be used or unused. For example, a single bit in the bitmap may correspond to one transmission occasion in a period. The UE indicates the skipping for future occasions in a bitmap with a sliding window. The UE indicates the skipping for a single CG period.

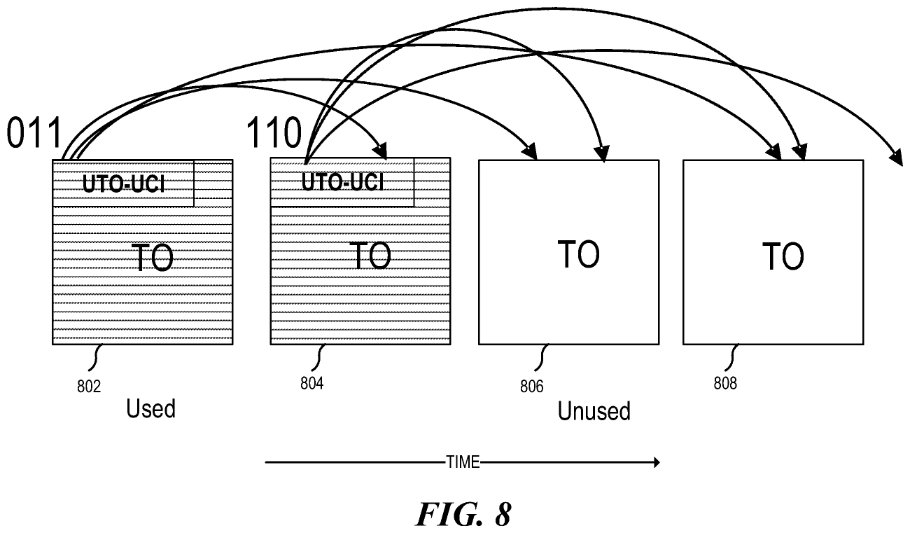

FIG. 8 is a block diagram illustrating unused transmission occasion-uplink control information (UTO-UCI) carried on a physical uplink shared channel (PUSCH). In the example of FIG. 8, the UE indicates in a sliding window, the skipping over multiple occasions using 1 or 0 in a bitmap. The window size may be radio resource control (RRC) configured with three to eight occasions. In the example of FIG. 8, the UE uses a first transmission occasion (TO) 802 and a second transmission occasion 804, but does not use a third transmission occasion 806 or a fourth transmission occasion 808. Thus, the UE transmits 011 at the first transmission occasion 802 to indicate that the next transmission occasion 804 will be used, but the following two transmission occasions 806, 808 will not be used. The UE transmits 110 at the second transmission occasion 804 to indicate that the next two transmission occasions 806, 808 will not be used, and subsequent transmission occasion (not shown) will be used.

As noted previously, a high PDCCH blocking rate may result from a lack of available control channel elements (CCE). For example, uplink or downlink (UL/DL) physical resource block (PRB) usage may be approximately 30 percent in a busy time period or hot spot. Thus, not all UEs may be scheduled due to the large number of downlink control information (DCI) messages needed for scheduling.

Moreover, because every slot carries a DMRS for both uplink and downlink transmissions, a high overhead is incurred for the DMRS for both the PDSCH and PUSCH. A high overhead results in a low spectrum efficiency

If channel conditions are good, the same precoding may be applied for consecutive slots. The channel conditions may be determined based on radio frequency (RF) conditions, application quality of service (QOS) latency specifications, and/or UE mobility.

According to aspects of the present disclosure, PDCCH blocking is addressed by allowing a single DCI message to schedule multiple TBs over multiple time slots to reduce CCE consumption. The UE may skip remaining uplink slots if there is no more data in the UE buffer. The UE may indicate the skipping to the base station (e.g., gNB) via UTO-UCI.

Aspects of the present disclosure address DMRS overhead by allowing dynamic or adaptive partial or no DMRS transmissions in the time domain based on channel conditions, application QoS latency specifications, and/or UE mobility. A bit map may indicate which slots carry DMRS and which slots do not carry DMRS. Data may be carried in the symbols not carrying DMRS, thereby reducing overhead.

FIG. 9 is a call flow diagram illustrating single DCI scheduling of multiple transport blocks (TBs) over multiple slots with partial DMRS, in accordance with various aspects of the present disclosure. In the example of FIG. 9, at time 902, a UE 120 indicates a capability to support a single DCI scheduling multiple TBs over multiple slots with partial DMRS. In some aspects, the grant for each slot has the same modulation and coding scheme (MCS), multiple-input, multiple-output (MIMO) layer, frequency domain resource allocation (FDRA), and time domain resource allocation (TDRA) to reduce the DCI bit size. A bit mapping indicates which slots have a partial DMRS or have no DMRS. The bitmap also indicates a number of DMRS symbols for each of the uplink time slots, which may be consecutive or non-consecutive.

At time 904, a base station (e.g., gNB) 110 dynamically decides whether to use single DCI scheduling of multiple TBs over multiple slots with partial DMRS. If so, at time 906, the base station 110 transmits, to the UE 120, a message enabling and configuring single DCI scheduling for multiple TBs over multiple slots with partial DMRS. The configuration may be via RRC signaling. The maximum number of slots may be indicated as two, four, eight, or sixteen slots, in some aspects. The time slots may be consecutive or non-consecutive.

At time 908, the UE 120 optionally transmits a preference for single DCI scheduling of multiple TBs over multiple slots with partial DMRS. The preference may be indicated via RRC signaling or a media access control-control element (MAC-CE), for example. The UE 120 may request single DCI scheduling for multiple TBs over multiple slots with partial DMRS based on radio frequency (RF) variation, mobility, or application quality of service (QOS) latency specifications. For example, if a good channel conditions exists, DMRS (or partial DMRS) may be requested in fewer (or no) time slots. Partial DMRS refers to fewer DMRS symbols than a quantity of DMRS that were configured by RRC signaling.

At time 910, the base station 110 transmits a single PDCCH with multiple slot scheduling. The PDCCH includes a DCI message. The number of slots scheduled may be configured at time 906. For example, number of slots may be up to the maximum number. The DCI indicates a number of consecutive or non-consecutive uplink/downlink slots. The DCI may also include a bitmap indicating DMRS density in each slot.

In some aspects of transport blocks over multiple slots with partial DMRS, the UE 120 performs channel estimation only on slots with full or partial DMRS. That is, channel estimation may be performed on time slots without full DMRS symbols. PUSCH decoding may then be based on the channel estimation of the slots with full or partial DMRS. As a result of the reduced DMRS symbols, more symbols or resource elements (REs) are available for PDSCH/PUSCH on the slots without DMRS transmission/reception. The UE 120 may skip transmitting on remaining uplink slots if there is no more data in the UE buffer. The UE 120 may indicate to the base station 110 via UTO-UCI over PUSCH, which future uplink slots are to be skipped. The indication may be in the form of a bitmap.

At time 912, the base station 110 dynamically decides if single DCI scheduling of multiple TBs over multiple slots with partial DMRS should remain enabled. For example, based on radio frequency (RF) conditions, application QoS latency specifications, or UE mobility, the base station 110 may adaptively and dynamically enable or disable multiple slot scheduling.

At time 914, the base station 110 may release single DCI scheduling of multiple TBs over multiple slots with partial DMRS, based on the decision at time 912. Subsequently, at time 916, the base station 110 may transmit a PDCCH with single slot scheduling.

Aspects of the present disclosure allow single DCI scheduling of multiple TBs over multiple slots with partial DMRS for both PDCCH CCEs and PDSCH/PUSCH DMRS overhead reduction. These aspects boost throughput and spectrum efficiency based on UE mobility, RF variations, application traffic burst specifications, or QoS latency specifications.

As indicated above, FIGS. 3-9 are provided as examples. Other examples may differ from what is described with respect to FIGS. 3-9.

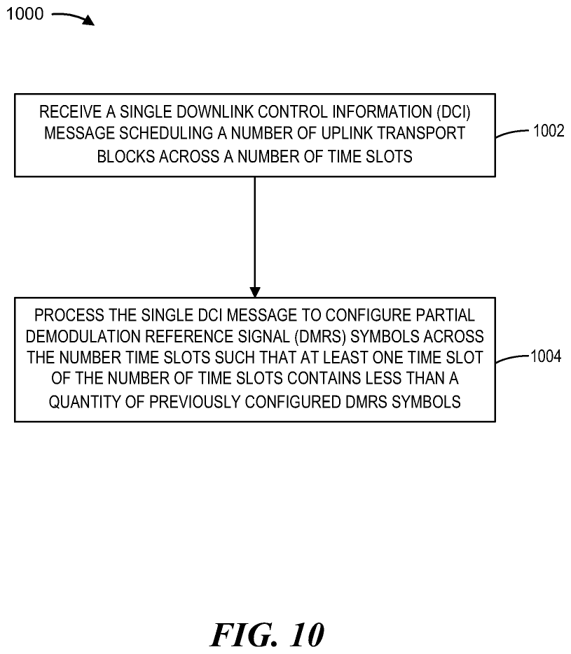

FIG. 10 is a flow diagram illustrating an example process 1000 performed, for example, by a user equipment (UE), in accordance with various aspects of the present disclosure. The example process 1000 is an example of a single downlink control information (DCI) message scheduling multiple transport blocks (TBs) over multiple time slots with partial demodulation reference signals (DMRS) by a UE. The operations of the process 1000 may be implemented by a UE 120.

At block 1002, the user equipment receives a single downlink control information (DCI) message scheduling a number of uplink transport blocks across a number of time slots. For example, the UE (e.g., using the antenna 252, DEMOD/MOD 254, MIMO detector 256, receive processor 258, controller/processor 280, memory 282, and/or the like) may receive the single DCI message. In some aspects, a grant for each of the time slots indicates a same modulation and coding scheme (MCS), a same multiple input multiple output (MIMO) layer, a same frequency domain resource allocation (FDRA), and a same time domain resource allocation (TDRA) for each of the uplink time slots. The time slots may be either consecutive or non-consecutive. The single DCI message may include a bitmap configuring the partial DMRS symbols, the bitmap indicating a quantity of DMRS symbols for each of the uplink time slots.

At block 1004, the user equipment processes the single DCI message to configure partial demodulation reference signal (DMRS) symbols across the number of time slots such that at least one time slot of the number of time slots contains less than a quantity of previously configured DMRS symbols. For example, the UE (e.g., using the controller/processor 280, memory 282, and/or the like) may process the single DCI message. In some aspects, the UE may request the single DCI message scheduling the uplink transport blocks based on measured uplink channel conditions, application quality of service (QOS) latency specifications, and/or UE mobility.

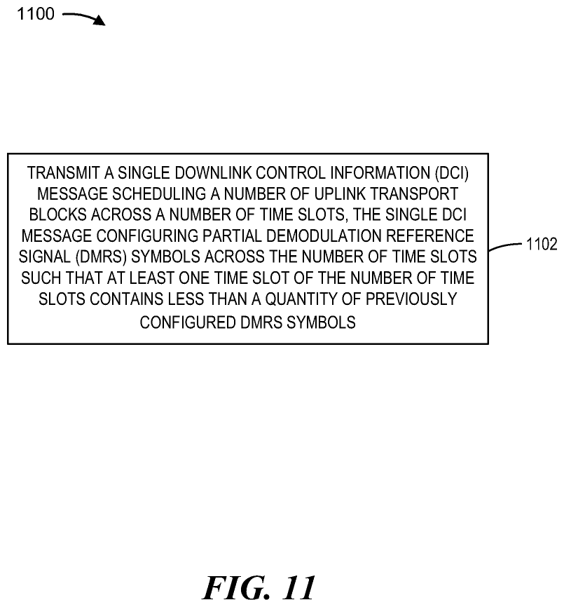

FIG. 11 is a flow diagram illustrating an example process 1100 performed, for example, by a network device, in accordance with various aspects of the present disclosure. The example process 1100 is an example of a single downlink control information (DCI) message scheduling multiple transport blocks (TBs) over multiple time slots with partial demodulation reference signals (DMRS) by a network device. The operations of the process 1100 may be implemented by a base station 110.

At block 1102, the base station transmits a single downlink control information (DCI) message scheduling a number of uplink transport blocks across a number of time slots, the single DCI message configuring partial demodulation reference signal (DMRS) symbols across the number of time slots such that at least one time slot of the number of time slots contains less than a quantity of previously configured DMRS symbols. For example, the base station (e.g., using the antenna 234, MOD/DEMOD 232, TX MIMO processor 230, transmit processor 220, controller/processor 240, memory 242, and/or the like) may transmit the single DCI message. In some aspects, a grant for each of the time slots indicates a same modulation and coding scheme (MCS), a same multiple input multiple output (MIMO) layer, a same frequency domain resource allocation (FDRA), and a same time domain resource allocation (TDRA) for each of the uplink time slots. The time slots may be either consecutive or non-consecutive. The single DCI message may include a bitmap configuring the partial DMRS symbols, the bitmap indicating a quantity of DMRS symbols for each of the uplink time slots.

### EXAMPLE ASPECTS

Aspect 1: A method of wireless communication by a user equipment (UE), comprising: receiving a single downlink control information (DCI) message scheduling a plurality of uplink transport blocks across a plurality of time slots; and processing the single DCI message to configure partial demodulation reference signal (DMRS) symbols across the plurality of time slots such that at least one time slot of the plurality of time slots contains less than a quantity of previously configured DMRS symbols.
Aspect 2: The method of Aspect 1, further comprising transmitting a UE capability message indicating support of the single DCI message scheduling the plurality of uplink transport blocks with partial DMRS symbols.
Aspect 3: The method of Aspect 1 or 2, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.
Aspect 4: The method of any of the preceding Aspects, in which the single DCI message includes a bitmap configuring the partial DMRS symbols, the bitmap indicating a quantity of DMRS symbols for each of the plurality of uplink time slots, the plurality of time slots being either consecutive or non-consecutive.
Aspect 5: The method of any of the preceding Aspects, further comprising performing channel estimation only on time slots including full or partial DMRS symbols.
Aspect 6: The method of any of the preceding Aspects, further comprising decoding a physical uplink shared channel (PUSCH) on time slots including the full or partial DMRS symbols on which the channel estimation is performed.
Aspect 7: The method of any of the preceding Aspects, further comprising: transmitting an unused transmission occasion uplink control information (UTO-UCI) message carried on a physical uplink shared channel (PUSCH) in response to detecting an empty uplink buffer before the plurality of time slots have ended; and refraining from PUSCH transmission on a time slot indicated in the UTO-UCI message.
Aspect 8: The method of any of the preceding Aspects, further comprising requesting the single DCI message scheduling the plurality of uplink transport blocks based on measured uplink channel conditions, application quality of service (QOS) latency specifications, and/or UE mobility.
Aspect 9: A method of wireless communication by a network device, comprising: transmitting a single downlink control information (DCI) message scheduling a plurality of uplink transport blocks across a plurality of time slots, the single DCI message configuring partial demodulation reference signal (DMRS) symbols across the plurality of time slots such that at least one time slot of the plurality of time slots contains less than a quantity of previously configured DMRS symbols.
Aspect 10: The method of Aspect 9, further comprising receiving a user equipment (UE) capability message indicating support of the single DCI message scheduling the plurality of uplink transport blocks with partial DMRS symbols.
Aspect 11: The method of Aspect 9 or 10, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.
Aspect 12: The method of any of the Aspects 9-11, in which the single DCI message includes a bitmap configuring the partial DMRS symbols, the bitmap indicating a quantity of DMRS symbols for each of the plurality of uplink time slots, the plurality of time slots being either consecutive or non-consecutive.
Aspect 13: The method of any of the Aspects 9-12, further comprising receiving a request for the single DCI message scheduling the plurality of uplink transport blocks with partial DMRS symbols based on measured uplink channel conditions, application quality of service (QOS) latency specifications, and/or user equipment (UE) mobility.
Aspect 14: An apparatus for wireless communication by a user equipment (UE), comprising: at least one memory; and at least one processor coupled to the at least one memory, the at least one processor configured: to receive a single downlink control information (DCI) message scheduling a plurality of uplink transport blocks across a plurality of time slots; and to process the single DCI message to configure partial demodulation reference signal (DMRS) symbols across the plurality of time slots such that at least one time slot of the plurality of time slots contains less than a quantity of previously configured DMRS symbols.
Aspect 15: The apparatus of Aspect 14, in which the at least one processor is further configured to transmit a UE capability message indicating support of the single DCI message scheduling the plurality of uplink transport blocks with partial DMRS symbols.
Aspect 16: The apparatus of Aspect 14 or 15, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.
Aspect 17: The apparatus of any of the Aspects 14-16, in which the single DCI message includes a bitmap configuring the partial DMRS symbols, the bitmap indicating a quantity of DMRS symbols for each of the plurality of uplink time slots, the plurality of time slots being either consecutive or non-consecutive.
Aspect 18: The apparatus of any of the Aspects 14-17, in which the at least one processor is further configured to perform channel estimation only on time slots including full or partial DMRS symbols.
Aspect 19: The apparatus of any of the Aspects 14-18, in which the at least one processor is further configured: to transmit an unused transmission occasion uplink control information (UTO-UCI) message carried on a physical uplink shared channel (PUSCH) in response to detecting an empty uplink buffer before the plurality of time slots have ended; and to refrain from PUSCH transmission on a time slot indicated in the UTO-UCI message.
Aspect 20: The apparatus of any of the Aspects 14-19, in which the at least one processor is further configured to request the single DCI message scheduling the plurality of uplink transport blocks based on measured uplink channel conditions, application quality of service (QOS) latency specifications, and/or UE mobility.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE), comprising:
receiving a single downlink control information (DCI) message scheduling a plurality of uplink transport blocks across a plurality of time slots; and
processing the single DCI message to configure partial demodulation reference signal (DMRS) symbols across the plurality of time slots such that at least one time slot of the plurality of time slots contains less than a quantity of previously configured DMRS symbols.

2. The method of claim 1, further comprising transmitting a UE capability message indicating support of the single DCI message scheduling the plurality of uplink transport blocks with partial DMRS symbols.

3. The method of claim 1, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.

4. The method of claim 1, in which the single DCI message includes a bitmap configuring the partial DMRS symbols, the bitmap indicating a quantity of DMRS symbols for each of the plurality of uplink time slots, the plurality of time slots being either consecutive or non-consecutive.

5. The method of claim 1, further comprising performing channel estimation only on time slots including full or partial DMRS symbols.

6. The method of claim 5, further comprising decoding a physical uplink shared channel (PUSCH) on time slots including the full or partial DMRS symbols on which the channel estimation is performed.

7. The method of claim 1, further comprising:
transmitting an unused transmission occasion uplink control information (UTO-UCI) message carried on a physical uplink shared channel (PUSCH) in response to detecting an empty uplink buffer before the plurality of time slots have ended; and
refraining from PUSCH transmission on a time slot indicated in the UTO-UCI message.

8. The method of claim 1, further comprising requesting the single DCI message scheduling the plurality of uplink transport blocks based on measured uplink channel conditions, application quality of service (QOS) latency specifications, and/or UE mobility.

9. A method of wireless communication by a network device, comprising:
transmitting a single downlink control information (DCI) message scheduling a plurality of uplink transport blocks across a plurality of time slots, the single DCI message configuring partial demodulation reference signal (DMRS) symbols across the plurality of time slots such that at least one time slot of the plurality of time slots contains less than a quantity of previously configured DMRS symbols.

10. The method of claim 9, further comprising receiving a user equipment (UE) capability message indicating support of the single DCI message scheduling the plurality of uplink transport blocks with partial DMRS symbols.

11. The method of claim 9, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.

12. The method of claim 9, in which the single DCI message includes a bitmap configuring the partial DMRS symbols, the bitmap indicating a quantity of DMRS symbols for each of the plurality of uplink time slots, the plurality of time slots being either consecutive or non-consecutive.

13. The method of claim 9, further comprising receiving a request for the single DCI message scheduling the plurality of uplink transport blocks with partial DMRS symbols based on measured uplink channel conditions, application quality of service (QOS) latency specifications, and/or user equipment (UE) mobility.

14. An apparatus for wireless communication by a user equipment (UE), comprising:
at least one memory; and
at least one processor coupled to the at least one memory, the at least one processor configured:
to receive a single downlink control information (DCI) message scheduling a plurality of uplink transport blocks across a plurality of time slots; and
to process the single DCI message to configure partial demodulation reference signal (DMRS) symbols across the plurality of time slots such that at least one time slot of the plurality of time slots contains less than a quantity of previously configured DMRS symbols.

15. The apparatus of claim 14, in which the at least one processor is further configured to transmit a UE capability message indicating support of the single DCI message scheduling the plurality of uplink transport blocks with partial DMRS symbols.

16. The apparatus of claim 14, in which a grant for each of the plurality of time slots indicates a same modulation and coding scheme (MCS), a same multiple input multiple output (MIMO) layer, a same frequency domain resource allocation (FDRA), and a same time domain resource allocation (TDRA) for each of the plurality of uplink time slots, the plurality of time slots being either consecutive or non-consecutive.

17. The apparatus of claim 14, in which the single DCI message includes a bitmap configuring the partial DMRS symbols, the bitmap indicating a quantity of DMRS symbols for each of the plurality of uplink time slots, the plurality of time slots being either consecutive or non-consecutive.

18. The apparatus of claim 14, in which the at least one processor is further configured to perform channel estimation only on time slots including full or partial DMRS symbols.

19. The apparatus of claim 14, in which the at least one processor is further configured:
to transmit an unused transmission occasion uplink control information (UTO-UCI) message carried on a physical uplink shared channel (PUSCH) in response to detecting an empty uplink buffer before the plurality of time slots have ended; and
to refrain from PUSCH transmission on a time slot indicated in the UTO-UCI message.

20. The apparatus of claim 14, in which the at least one processor is further configured to request the single DCI message scheduling the plurality of uplink transport blocks based on measured uplink channel conditions, application quality of service (QOS) latency specifications, and/or UE mobility.
